(19) United States
(12) Patent Application Publication
(10) Pub. No.: US 2024/0298604 A1
(43) Pub. Date: Sep. 12, 2024

(54) ANIMAL LITTER FILLER

(71) Applicant: TF Pet IP Pty Ltd, Brisbane (AU)

(72) Inventor: Min JIN, Brisbane (AU)

(21) Appl. No.: 18/578,245

(22) PCT Filed: Jun. 23, 2022
(86) PCT No.: PCT/AU2022/050632

§ 371 Date: Jan. 10, 2024

(30) Foreign Application Priority Data
Jul. 12, 2021 (AU) 2021104066

(51) Int. Cl. A01K 1/015

(52) U.S. Cl. CPC A01K 1/0155; A01K 1/0154

(57) ABSTRACT

An animal litter filler for use in an animal litter container including at least one litter filler granular material and at least one treatment solution derived from deposited marine substances (shells, organic matters, deposited minerals), mineral substances from volcanic ash, rosemary, sesamin, mugwort (Artemisia vulgaris), Coltsfoot (Tussilago farfara), plants derived from Sasa, cherry blossom, plants derived from Nelumbonaceae, humic acid, plant-based aerobic bacteria and anaerobic bacteria, and soil-based aerobic bacteria and anaerobic bacteria.

### FIELD OF INVENTION

The present invention relates to litter filler for animals and method of using the litter filler. In particular, the present invention relates, but is not limited, to litter filler with effective odour control and antimicrobial effect for animals including cats. Reference to the litter filler with effective odour control and antimicrobial effect for cats is provided by way of example but the invention is not limited to this use.

### BACKGROUND OF THE INVENTION

It is a general instinct for animals including cats to defecate in dirt or sand, they would then use the dirt or sand to cover their own excrement including urine and faeces in order to hide their scent. For household animals, a caretaker typically uses a litter container lined with litter filler for the animal. Litter filler is a loose, granular material that generally helps to absorb the moisture from the urine and faeces. The loose, granular form of the litter filler also satisfy the animal's instinctive desire to cover their own excrement.

Accumulation of the animal's excrement in the litter container or improper maintenance of the litter container can result in unpleasant odour in the household. In addition, animals' excrement may include pathogens including viruses, bacteria and parasites. Exposure to poorly managed animal excrement can cause pathogenic infection. Constant cleaning of the litter container and replacing the litter filler can help to reduce the odour and exposure to the animals' excrement. However, it is time consuming to clean the litter container and can be costly to frequently replacing the litter filler.

Unpleasant odour may be reduced by the type of litter filler material used. Litter filler are generally made of five different types of materials, including clay, paper, wood, sodium silicate, and plant-based material. Depending on the type of materials, litter filler can achieve deodorisation by physical adsorption. However, clay, paper and wood generally have a limited absorption ability and is not effective in reducing odour. Sodium silicate and plant-based material typically further included a chemical deodorising agent for odour control. However, chemical deodorising agent generally relies on strong artificial fragrance to mask the odour instead of eliminating the odour. Animals are generally sensitive to and is driven away by the strong fragrance smell. The strong fragrance smell may also mix up with the odour from the animal excrement and can produce an even worse odour. Chemical deodorising agent may also be toxic to the animals due to skin contact and or accidental ingestion.

### OBJECT OF THE INVENTION

It is an objective of the present invention to overcome or at least alleviate one or more of the disadvantages or problems with litter filler for animals described above and/or provide the consumer with a useful or commercial alternative.

### SUMMARY OF THE INVENTION

In one aspect, the present invention broadly resides in an animal litter filler for use in an animal litter container including
at least one litter filler granular material and
at least one treatment solution.

Preferably, the treatment solution includes a deodorising agent. Preferably, the treatment solution includes an antimicrobial agent. Preferably, the treatment solution includes an antimicrobial and deodorising agent.

Preferably, the treatment solution is a natural treatment solution. Preferably, the treatment solution is a natural organic and plant-based treatment solution. Preferably, the natural organic and plant-based treatment solution includes but is not limited to one or more of humic acid, rosemary oil, sesamin, Artemisia vulgaris extract, Tussilago farfara extract, Sasa extract, cherry blossom extract, Nelumbonaceae extract, and mineral water.

Preferably, the natural organic and plant-based treatment solution is produced from components including but not limited to deposited marine substances (shells, organic matters, deposited minerals), mineral substances from volcanic ash, rosemary, sesamin, mugwort (Artemisia vulgaris), Coltsfoot (Tussilago farfara), plants derived from Sasa, cherry blossom, plants derived from Nelumbonaceae, humic acid, plant-based aerobic bacteria and anaerobic bacteria, and soil-based aerobic bacteria and anaerobic bacteria.

Preferably, the treatment solution has a concentration of 0.1 to 20% w/v of active ingredients. Preferably, the treatment solution has a concentration of substantially 10% w/v of active ingredients. Preferably, the treatment solution has a concentration of 10 to 200 mg/ml of active ingredients. Preferably, the treatment solution has a concentration of substantially 100 mg/ml of active ingredients.

Preferably, the treatment solution is non-toxic to animals.

The treatment solution is preferably a bio-enzymatic solution. Preferably the bio-enzymatic solution has a deodorising effect. Preferably the bio-enzymatic solution has an antimicrobial effect.

Preferably, the animal litter filler contains 0.1 to 10 ml of the at least one treatment solution per gram of the at least one litter filler granular material. Preferably, the litter filler contains substantially 0.5 ml of the at least one treatment solution per gram of the at least one litter filler granular material.

Preferably, the at least one litter filler granular material includes a plant-based material. Preferably, the plant-based material includes but not limited to one or more of the following ingredients: soybean fibre, corn starch, peas, and tapioca flour. More preferably the plant-based material is soybean fibre

Preferably, the animal litter filler has a granular diameter of between 1 to 3 mm. Preferably, the animal litter filler has a granular diameter of substantially 1.5 mm. Preferably, the animal litter filler has a granular length between 10 to 100 mm, more preferably between 30 to 80 mm. Preferably, the animal litter filler has a granular length between 50 to 60 mm.

Preferably, the animal litter filler has a liquid absorption capacity of between 100% to 600%, more preferably between 250% to 400%. Preferably, the animal litter filler has a liquid absorption capacity of substantially 400%.

Preferably, the animal litter filler further includes sodium bicarbonate. Preferably, the concentration of the sodium bicarbonate in the animal litter filler is between 0.5% to 2.5% w/w. Preferably, the concentration of the sodium bicarbonate in the animal litter filler is substantially 1% w/w.

Preferably, the litter filler further includes activated charcoal. Preferably, the concentration of the activated charcoal in the animal litter filler is between 0.01% to 1% w/w. Preferably, the concentration of the activated charcoal in the animal litter filler is substantially 0.1% w/w.

In another aspect, the present invention broadly resides in a deodorising agent for animal litter filler including a treatment solution as described herein, wherein the treatment solution can achieve substantial deodorisation when used with the animal litter filler in an animal litter container.

Preferably, the treatment solution can achieve substantial deodorisation by reducing odour gases generated from animal excrement. Preferably, the odour gases include but not limited to ammonia, trimethylamine and hydrogen sulfide.

In one embodiment, the deodorising agent is fragrance-free.

In another aspect, the present invention broadly resides in an antimicrobial agent for animal litter filler including a treatment solution as described herein, wherein the treatment solution can achieve substantial antimicrobial effect when used with the animal litter filler in an animal litter container.

Preferably, the treatment solution can achieve substantial antimicrobial effect against bacteria in animal excrement includes but not limited to Staphylococcus aureus, Pseudomonas aeruginosa, and Escherichia coli.

In another aspect, the present invention broadly resides in a system of collecting animals' excrement, the system includes
the animal litter filler as described herein, and
an animal litter container.

Preferably, the animal litter filler is added to the animal litter container to cover at least 3 cm over the bottom of the animal litter container. Preferably, the animal litter filler is added to the animal litter container to cover substantially 5 cm over the bottom of the animal litter container.

In another aspect, the present invention broadly resides in a method of manufacturing an animal litter filler as described herein, the method includes adding an effective amount of at least one treatment solution as described herein to at least one litter filler granular material.

Preferably, the method of manufacturing the animal litter filler includes
mixing one or more ingredients for the litter filler granular material to form a mixture; and
forming and drying the mixture to produce the animal litter filler.

In one embodiment, the step of adding an effective amount of at least one treatment solution is carried out before the step of mixing one or more ingredients. In another embodiment, the step of adding an effective amount of at least one treatment solution is carried out after the step of mixing one or more ingredients and before forming and drying the mixture. Preferably, the method further includes a step of mixing the at least one treatment solution with the mixture.

In one embodiment, the step of forming and drying the mixture includes heating the mixture to a temperature between the range of 70 to 90° C. Preferably the mixture is heated for a predetermined period of time. Preferably, the step of heating the mixture is at a temperature of substantially 80° C. In another embodiment, the step of forming and drying the mixture includes compressing the mixture under high pressure to produce the animal litter filler. Preferably, the step of compressing the mixture is at a compression ratio of 5:1 to 10:1. Preferably, the step of compressing the mixture is at a compression ratio of substantially 7:1. In another embodiment, the step of forming and drying the animal litter filler includes compressing the mixture at a compression ratio of substantially 7:1 and heating the mixture at a temperature of substantially 80° C. for a predetermined period of time to produce the animal litter filler.

In one embodiment, the step of forming and drying the mixture to produce the animal litter filler further includes drying the animal litter filler with heat. Preferably, the step of drying the animal litter filler includes drying the animal litter filler at or below 60° C. More preferably, the step of drying the animal litter filler includes drying the animal litter filler at or below 50° C. In another embodiment, the step of forming and drying the mixture to produce the animal litter filler further includes drying the animal litter filler with a dehumidifying technique. In another embodiment, the step of forming and drying the mixture to produce the animal litter filler further includes drying the animal litter filler with heat and with a dehumidifying technique.

Preferably, the method further includes a step of adding sodium bicarbonate to the animal litter filler. Preferably, the sodium bicarbonate is added after the step of forming and drying the mixture to produce the animal litter filler. Preferably, the concentration of the sodium bicarbonate in the animal litter filler is between 0.5% to 2.5%. Preferably, the concentration of the sodium bicarbonate in the animal litter filler is substantially 1%. Preferably, the animal litter filler has a pH value of 9 or below after the addition of the sodium bicarbonate

Preferably, the method further includes a step of shaping the animal litter filler to a suitable size. Preferably, the step of shaping the animal litter filler is carried out after the step of forming the animal litter filler. Preferably, the step of shaping the animal litter filler to a suitable size includes granulising the animal litter filler. In another embodiment, the step of shaping the animal litter filler to a suitable size includes pelletising the animal litter filler.

In another aspect, the invention resides in a method of manufacturing an animal litter filler as claimed in any one of the preceding claims, the method including the steps of
mixing one or more ingredients to form the litter filler granular material;
adding an amount of the at least one treatment solution to the at least one litter filler granular material; and
forming and drying the mixture to produce the animal litter filler.

The animal litter filler is preferably usable as cat litter filler.

The features described with respect to one aspect also apply where applicable to all other aspects of the invention. Furthermore, different combinations of described features are herein described and claimed even when not expressly stated.

### DETAILED DESCRIPTION OF THE PREFERRED EMBODIMENT

The present invention is further described by the following preferred embodiment.

The abovementioned animal litter filler is a plant-based animal litter that is known as “tofu animal litter” filler. The tofu animal litter filler includes a treatment solution that is known as GT-S solution. The tofu animal litter filler further includes baking soda (sodium bicarbonate) and activated carbon for enhancing liquid absorption and odour control.

GT-S solution is a natural organic and plant-based treatment solution that includes humic acid (CAS No. 1415-93-6), rosemary oil (CAS No. 8000-25-7), sesamin (CAS No. 607-80-7), Artemisia vulgaris extract (CAS No. 84775-45-1), Tussilago farfara extract (CAS No. 84625-50-3), Sasa extract, cherry blossom extract, Nelumbonaceae extract, and mineral water. GT-S solution is produced from ingredients including deposited marine substances (shells, organic matters, deposited minerals), mineral substances from volcanic ash, rosemary, sesamin, mugwort (Artemisia vulgaris), Coltsfoot (Tussilago farfara), plants derived from Sasa, cherry blossom, plants derived from Nelumbonaceae, humic acid, plant-based aerobic bacteria and anaerobic bacteria, and soil-based aerobic bacteria and anaerobic bacteria.

GT-S solution is known to have deodorising effect. Specifically, laboratory test has been conducted on the effect of GT-S solution on three type of odour gases including ammonia, trimethylamine and hydrogen sulfide. To test the deodorising effect, 0.5 ml of GT-S solution is added to 1 g of polyester cotton. The polyester cotton is then placed in a sealed sample bag that contains 2000 ml of odour gas. A gas detector is used to determine the odour gas concentration at time intervals of 0, 10, 30, 60 and 180 minutes. The treatment solution can substantially reduce at least 80% of ammonia and at least 80% of trimethylamine generated from the animal excrement in substantially 10 min, and at least 5% of hydrogen sulfide generated from the animal excrement in substantially 30 min. The laboratory test results show that 0.5 ml of GT-S solution can remove substantially 85% of ammonia and 98.5% of trimethylamine in 10 min, and substantially 6.3% of hydrogen sulfide can be removed by the GT-S solution in 30 min. GT-S solution is further shown to remove 100% of trimethylamine in 30 min, and 98% of ammonia and 20% of hydrogen sulfide can be removed after 180 min.

GT-S solution is also known to have antimicrobial effect. Specifically, laboratory test has been conducted on the effect of 100 mg/ml of GT-S solution on Staphylococcus aureus, Pseudomonas aeruginosa, and Escherichia coli. The treatment solution can substantially reduce at least 15% of Staphylococcus aureus, at least 95% of Pseudomonas aeruginosa, and at least 45% of Escherichia coli in the animal excrement in substantially 0.5 hour. It is shown that GT-S solution can reduce 17.5% of Staphylococcus aureus, 99.6% of Pseudomonas aeruginosa and 48.7% of Escherichia coli in 0.5 hour, and 26.8% of Staphylococcus aureus, 99.9% of Pseudomonas aeruginosa and 84.8% of Escherichia coli in 1 hour.

The GT-S solution is added to the tofu animal litter filler by a method that retains the deodorising and antimicrobial effect. To produce the tofu animal litter filler, dry peas and dry corn are mixed with the GT-S solution to form a mixture. The mixture is then compressed at a compressing ratio of 7:1 and heated at 80° C. for 0.1 to 0.2 second to form the animal litter filler. The animal litter filler is then dried at below 50° C. in combination with a dehumidifying technique. Sodium bicarbonate is then added to the litter filler granular material to a final concentration of 1% such that the tofu animal litter filler has a pH of below 9. A pH of below 9 is beneficial for the deodorising and antimicrobial activity of the GT-S solution. Activated charcoal is also added to the tofu animal litter filler to a final concentration of 0.1%.

The animal litter filler has a granular diameter of substantially 1.5 mm and has a liquid absorption capacity of 400%. The 1.5 mm diameter provides a soft feeling for the animal's paw and is safe to walk over the animal litter filler.

In use, the animal litter filler is added to an animal litter container that covers substantially 5 cm over the bottom of the animal litter container.

### Advantages

An advantage of the preferred embodiment of the present invention includes providing an alternative animal litter filler with deodorising effect. Another advantage of the preferred embodiment of the present invention includes providing an alternative animal litter filler with antimicrobial effect. A further advantage of the preferred embodiment of the present invention includes providing an alternative animal litter filler that can be easily and safely disposed of. Another advantage of the preferred embodiment of the present invention includes providing an alternative animal litter filler that can be used in an animal litter container for a prolong period without replacing the animal litter filler. A further advantage of the preferred embodiment of the present invention includes providing an alternative animal litter filler that is not toxic to animal through skin contact or accidental ingestion. Another advantage of the preferred embodiment of the present invention includes providing an alternative animal litter filler that is not irritating to the animal. A further advantage of the preferred embodiment of the present invention includes providing an alternative animal litter filler that has a soft foot-feeling for cats and is safe for the cat to step on.

### Variations

While the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. An animal litter filler for use in an animal litter container including
at least one litter filler granular material and
at least one treatment solution.

2. The animal litter filler as claimed in claim 1, wherein the treatment solution is a bio-enzymatic solution.

3. The animal litter filler as claimed in claim 1, wherein the at least one litter filler granular material includes a plant-based material.

4. The animal litter filler as claimed in claim 3, wherein the plant based material includes soybean fibre.

5. The animal litter filler as claimed in claim 3, wherein the plant based material includes one or more of the following: corn starch, peas, and tapioca flour.

6. The animal litter filler as claimed in claim 1, wherein the at least one treatment solution is derived from one or more of the following: deposited marine substances, mineral substances from volcanic ash, rosemary, sesamin, mugwort (Artemisia vulgaris), Coltsfoot (Tussilago farfara), plants derived from Sasa, cherry blossom, plants derived from Nelumbonaceae, humic acid, plant-based aerobic bacteria and anaerobic bacteria, and soil-based aerobic bacteria and anaerobic bacteria.

7. The animal litter filler as claimed in claim 1, further including sodium bicarbonate.

8. The animal litter filler as claimed in claim 7, wherein the concentration of the sodium bicarbonate in the animal litter filler is between 0.5% to 2.5% w/w.

9. The animal litter filler as claimed in claim 1, further including activated charcoal.

10. The animal litter filler as claimed in claim 9, wherein the concentration of the activated charcoal in the animal litter filler is between 0.01% to 1% w/w.

11. The animal litter filler as claimed in claim 1, wherein the treatment solution has a deodorising effect.

12. The animal litter filler as claimed in claim 1, wherein the treatment solution has an antimicrobial effect.

13. The animal litter filler as claimed in claim 1, wherein the treatment solution is a natural organic and plant-based treatment solution.

14. The animal litter filler as claimed in claim 13, wherein the natural organic and plant-based treatment solution includes but is not limited to one or more of humic acid, rosemary oil, sesamin, Artemisia vulgaris extract, Tussilago farfara extract, Sasa extract, cherry blossom extract, Nelumbonaceae extract, and mineral water.

15. A method of manufacturing an animal litter filler as claimed in claim 1, the method including the steps of
mixing one or more ingredients to form the litter filler granular material;
adding an amount of the at least one treatment solution to the at least one litter filler granular material; and
forming and drying the mixture to produce the animal litter filler.

16. The method as claimed in claim 15, wherein the step of forming and drying the mixture includes heating the mixture to a temperature between 70° C. to 90° C.

17. The method as claimed in claim 15, wherein the step of forming and drying the mixture to produce the animal litter filler further includes drying the animal litter filler at or below 60° C.

18. The method as claimed in claim 15, further including the step of adding sodium bicarbonate to the animal litter filler at a concentration of between 0.5% to 2.5% w/w.

19. The method as claimed in claim 15, further including the step of adding activated charcoal to the animal litter filler at a concentration of between 0.01% to 1% w/w.

20. The method as claimed in claim 15, further including the step of granulating the animal litter filler, the granulated animal litter filler having a granular diameter of between 1 to 3 mm and a granular length between 10 to 100 mm.
